(19) United States
(12) Patent Application Publication
(10) Pub. No.: US 2004/0071943 A1
(43) Pub. Date: Apr. 15, 2004

(54) Image-recording sheet

(76) Inventors: Koji Kamiyama, Tama-city (JP); Shigeaki Dohgoshi, Sagamihara City (JP)

Correspondence Address: 3M INNOVATIVE PROPERTIES COMPANY, P.O. BOX 33427, ST. PAUL, MN, 55133-3427, US

(21) Appl. No.: 10/469,260

(22) PCT Filed: Apr. 2, 2002
(86) PCT No.: PCT/US02/10246

(30) Foreign Application Priority Data
Apr. 27, 2001 (JP) 2001-131573

(51) Int. Cl. B32B 3/00

(52) U.S. Cl. 428/195.1

(57) ABSTRACT

The present invention provides an image-recording sheet capable of improving the gloss of a color image recorded thereon without being accompanied with hot-offset even if a toner is disposed in a high concentration on the image-receptive layer. In particular, the inventive image-recording sheet comprises a paper substrate and an image-receptive layer formed on at least one surface of the paper substrate. The image-receptive layer has a ten-point average surface roughness (Rz) of 0.1 to 3.0 mm and contains a thermoplastic resin having storage modulus of 1×103 to 1×106 Pa at 160° C. The image-recording sheet, if desired, may comprise a gloss layer disposed between the paper substrate and the image-receptive layer.

### TECHNICAL FIELD

The present invention relates to an image-recording sheet, more particularly to an image-recording sheet suitable for image recording with an electrophotographic color copying machine or a color printer.

### BACKGROUND

In general, a copying machine and a printer record images through electrography. Illustrative images include letters, prints, lines and drawings or pictures on an image-recording sheet provided in the form of a printing paper, an overhead projector (OHP) film, and the like through electrophotography. Electrophotography, a general term of photography, is used to obtain an image by photoelectric phenomena and static electricity. Electrophotography is well known and can be generally carried out as follows.

First, a photoconductive layer made of a photosemiconductor is pre-charged with static electricity to make it photosensitive. Next, an image is projected onto the photoconductive layer by exposure using a camera. Then, the electric charge in the light parts of the image is eliminated to form an electrostatic latent image on the photoconductive layer. After that, a coloring fine particle (that is, a toner) having an electric charge opposite to that of the electrostatic latent image is adhered to the photoconductive layer to develop the electrostatic latent image and form a toned image. The toned image is transferred to an image-recording sheet with a transfer roll and fixed, for example, thermally with a fixing apparatus to record the image on the image-recording sheet. For a color image, after latent images are formed for respective color-separated light ray and the respective electrostatic latent images are developed using color toners (e.g., cyan, magenta, yellow, etc.) to obtain toned images, the color image is formed on the image-recording sheet.

Most of the image-recording sheets comprise an image-receptive layer formed on a substrate and, usually, a toned image is fixed to the image-receptive layer. For example, in image-recording sheets disclosed in JP-A-63-92965 and JP-A-11-160905, an image-receptive layer of a transparent resin is formed on a prescribed paper substrate, and the gloss of the color images on the image-recording sheet is improved by decreasing the surface unevenness by burying the toner in the image-receptive layer in the course of thermal fixing.

In the case where a toner is disposed on an image-receptive layer in a high concentration, often a plurality of toner particles are disposed on top of one another. In such a case, when the image-recording sheets disclosed in the above-described patent applications are used, it is difficult to completely bury all of the toner particles in the image-receptive layer. As a result, the toner particles protrude over the image-receptive layer and scatter light thus reducing the gloss of the color images.

When the thickness of the image-receptive layers are increased, all the toner particles may be buried completely in the image-receptive layer. However, when the image-recording sheet has a thick image-receptive layer, it is accompanied with hot-offset possibly leading to image defect.

Hence, what is needed is an image-recording sheet capable of providing high gloss of a color image recorded thereon without being accompanied with hot-offset even if a toner is disposed in a high concentration on the image-receptive layer.

### SUMMARY

The present invention has been completed in order to solve the above-described problems and provides an image-recording sheet comprising a paper substrate and an image-receptive layer formed at least one surface of the paper substrate, characterized in that the image-receptive layer has ten-point average surface roughness (Rz) of about 0.1 to 3.0 μm and contains a thermoplastic resin having a storage modulus of about 1×10³ to 1×10⁶ Pa at 160° C.

### BRIEF DESCRIPTION OF THE DRAWINGS

The present invention will be described in detail with the reference to the accompanying figure wherein:

FIG. 1 shows a cross-section of an illustrative embodiment of the image-recording sheet of the present invention comprising substrate 1, image-receptive layer 2, and gloss layer 3.

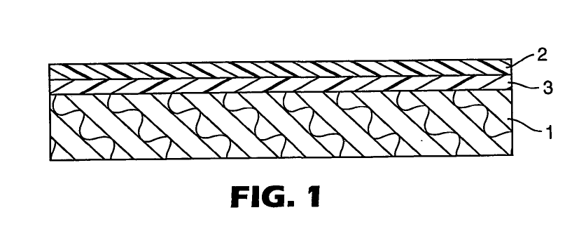

This figure is idealized, not drawn to scale, and is intended for illustrative purposes only.

### DETAILED DESCRIPTION

In a first preferred embodiment, the image-recording sheet of the present invention comprises substrate 1 and image-receptive layer 2 (without the gloss layer 3 in the first embodiment). In general, substrate 1 is a paper substrate and preferably at least a surface of the substrate, the surface on which the image-receptive layer is to be formed, is treated so as to have a ten-point average surface roughness (Rz) of about 0.1 to 3.0 μm. This treatment allows for smooth formation of the image-receptive layer, which will be described later.

Such a paper substrate includes coated paper such as enamel paper, art paper, synthetic paper, etc., and non-coated paper. The paper substrate basis weight is preferably within a range of 60 to 230 kg. When the basis weight is less than 60 kg, the stiffness of the paper substrate becomes weak and the transportability can be poor. On the contrary, when the basis weight exceeds 230 kg, the heat quantity necessary to sufficiently melt the toners becomes short and the gloss is lowered.

The image-receptive layer has a ten-point average surface roughness (Rz) of about 0.1 to 3.0 μm and is made glossy and supported while being adhered to at least one surface of the paper substrate. The image-receptive layer may be formed on both surfaces of the substrate.

In the present invention, the image-receptive layer is used for recording an image including letters, printings, lines and drawings, pictures or the like through the thermal fixing of a toned image.

In general, the image-receptive layer contains a thermoplastic resin. Suitable thermoplastic resin has a storage modulus of about 1×10³ to 1×10⁶ Pa at 160° C., and in the thermal fixation process around this temperature, the surface smoothness is not substantially reduced. Consequently, even with the thermal fixation process, the image-receptive layer is kept substantially smooth and it is possible to produce the image with good gloss.

When the thermoplastic resin has the storage modulus less than about 1×10³ at 160° C., the image-recording sheet tends to cause split of the toned image due to the hot-offset in the thermal fixation process. This problem can lead to image default and can cause contamination. On the contrary, when the thermoplastic resin has a storage modulus higher than about 1×10⁶ Pa at 160° C., the image-recording sheet cannot sufficiently closely fix the toned image on the image-receptive layer and thus tends to leave undesirable surface roughness on the toned image. Such unevenness may deteriorate the image quality.

The kind of the thermoplastic resin is not particularly limited as long as its storage modulus falls within the prescribed range. Preferably, acrylic resins, styrene resin, styrene-acrylic resins, epoxy resins, styrene-butadiene resins, polyurethane resins, or polyester resins are used. These resins have high transparency and are capable of maintaining image color reproducibility. These resins also have high compatibility with toners containing styrene resins, styrene-acrylic resins, polyester resins, polyetherpolyol resins, or mixtures of these resins. Thus, the resins can receive and hold almost all of the toner particles, even if the image-receptive layer is relatively thin. Furthermore, the hot-offset can effectively be avoided by making the image-receptive layer thin. Consequently, the image-recording sheet of the present invention can effectively lower the image defect and contamination following the defect.

The image-receptive transparent layer may further contain a compatibilizer. Although the compatibilizer is not specifically limited, it preferably has a solubility parameter (SP value) of about 8.0 to 10.0. When such a compatibilizer having a solubility parameter in the above-defined range is used, the toner easily melts in the thermal fixation process and becomes compatible with the thermoplastic resin to give a smooth image, and thus light scattering can be prevented. Furthermore, the compatibility of the toner particles with other toner particles in the surrounding is improved and, as a result, particularly in case of color toners, the color blending can be effectively promoted. When the toner contains styrene resin, styrene-acrylic resin, polyester resin, or their combination and is so designed as to record the image having the printed characters (a character-printed image) with the low gloss, the gloss of the image is improved and at the same time, the hue and the color reproducibility of the image are also improved. Moreover, such is true, even when a fixing apparatus is so designed as to record the image with the low gloss. Consequently, the image-recording sheet of the present invention can provide the image with the high gloss, hue, color reproducibility, and the like even in case of the color image including the lines and drawings and pictures without requiring a toner and a fixing apparatus to be specifically designed.

The above-described solubility parameter can be calculated according to the disclosure of P.A. Small, J, Appl. Chem., 3, 71(1953).

The inventive image-recording sheet may contain an antistatic agent. The antistatic agent controls the surface resistance of the image-receptive layer and increases the transfer efficiency of the toner, and thus improves the quality and other properties of the toned image. Preferable antistatic agents include nonionic antistatic agent, cationic antistatic agent, anionic antistatic agent, fluorine-containing antistatic agent, a combination of these antistatic agents and a salt (such as lithium nitrate, sodium nitrate, sodium chloride, etc.) and conductive polymers.

In another preferred embodiment of the present invention, the image-recording sheet further comprises the gloss layer 3 interposed between the substrate 1 and the image-receptive layer 2.

In the present invention, the gloss layer has a refractive index higher than that of the thermoplastic resin of the image-receptive layer by at least 0.002 in terms of absolute values. As a result, in the inventive image-recording sheet, even if light passes through the image-receptive layer, it is effectively reflected at the interface between the image-receptive layer 2 and the gloss layer 3 to improve the gloss of the image like the above described first embodiment and, at the same time, to improve the hue and color reproducibility of the image.

Such a gloss layer is made of a transparent optical material containing, for example, acrylic resin, styrene resin, styrene-acrylic resin, epoxy resin, styrene-butadiene resin, polyurethane resin, or polyester resin. Styrene-acrylic resin and polyester resin are preferred because of the high adhesion strength between the substrate and the image-receptive layer.

The above-described image-recording sheet can be produced by, for example, a conventional method as described below.

First, the thermoplastic resin and, if used, the compatibilizer are dissolved and dispersed in water or a volatile solvent containing methyl ethyl ketone (MEK) to obtain an over coating agent. A prescribed amount of the agent is applied to a substrate. After that, together with the substrate, the over coating agent is heated and dried to remove the solvent and to form an image-receptive layer with a desired dry coating amount.

The dry coating amount is preferably from about 0.5 to 15 g/m². When the dry coating amount is lower than about 0.5 g/m², a toned image tends to be difficult to smooth. On the other hand, when the dry coating amount exceeds about 15 g/m², the hot-offset of the image-receptive layer may be caused.

Furthermore, before the formation of the image-receptive transparent layer, if desired, a glossy primer layer may be formed on the substrate. The primer can be prepared by dissolving and dispersing an optical material containing the foregoing thermoplastic resin in water or a volatile solvent containing methyl ethyl ketone (MEK). The primer can then be applied to the substrate, and heated and dried together with the substrate.

The dry coating amount of the gloss layer is preferably from about 0.1 to 5 g/m². When the dry coating amount is lower than about 0.1 g/m², it may be difficult to evenly coat the layer and thus the thickness of the gloss layer may become less uniform. On the other hand, when the dry coating amount exceeds about 5 g/m², hot-offset is easily caused.

In the above, the image-recording sheet of the present invention is explained with reference to the preferred embodiments. The present invention, however, is not limited to those embodiments.

Also, the image-receptive layer may contain components other than those described above unless they are beyond the scope of the purposes and the effects of the present invention. For example, in order to adjust the whiteness of the image-recording sheet, a loading filler comprising an inorganic pigment such as calcium carbonate, clay, calcium sulfate, etc. or an acrylic type or a styrene-acrylic type organic pigment may be used.

Furthermore, a wax such as paraffin wax, microcrystalline wax, carnauba wax, etc. may be used. Such a wax is capable of efficiently separating the toner protruding over the image-receptive layer from the fixing apparatus (e.g., the fixing roll) in the thermal fixation process to prevent hot-offset. Furthermore, especially when the wax adheres to the surface of the toned image, the gloss of the toned image can further be improved.

### EXAMPLES

Hereinafter, the present invention will be illustrated by the following examples. However, a person skilled in the art can readily understand that the present invention is not limited to these examples.

### Example 1

In this example, at first, an over coating composition was prepared by mixing the respective components shown in Table 1.

TABLE 1

| Component | Parts by weight |
|---|---|
| Aqueous polyurethane | 50.72 |
| (Sancure 776 manufactured by Gunze Ltd.) | |
| di(butoxyethoxyethyl) adipate (BXA manufactured by | 10.65 |
| Daihachi Chemical Industry Co., Ltd.) | |
| poly(methyl methacrylate) beads (average particle size of | 0.09 |
| 8 μm; Techpolymer MBX-8 | |
| manufactured by Sekisui Plastics Co., Ltd.) | |
| surfactant (Zonyl FSN manufactured by DuPont) | 0.33 |
| lithium nitrate | 0.18 |
| deionized water | 30.04 |

Next, a prescribed amount of the obtained over coating composition was applied with a Mayer bar to one surface of a paper substrate (soft glossy paper, C4179B, manufactured by Hewlett-Packard) having a ten-point average surface roughness (Rz) of 0.146 μm. After that, together with the paper substrate, the over coating composition was heated to 100° C. and dried for 3 minutes to remove the solvent and form an image-receptive transparent layer with the dry coating amount of 4.0 g/m² and produce an image-recording sheet. In this case, the image-receptive layer was firmly adhered to the paper substrate.

The surface roughness of the image-receptive layer was measured with a surface roughness meter (Surfcoder SE-30K manufactured by Kosaka Laboratory Co., Ltd.) and the surface roughness Rz was found to be 1.232 μm.

Next, an image was printed on the image-recording sheet using a laser printer (Color Laser Shot LBP-2040 manufactured by Canon) to form a full color toned image on the image-receptive transparent layer and after that, the gloss and the chromas (a*, b*) of the image were measured to evaluate the quality of the image. The gloss was measured by gloss-meter manufactured by Nippon Denshoku Kogyo Co., Ltd. The measurement angle was set at 75°. The chromas were measured with a colorimeter/color difference meter (SZ-Σ80 manufactured by Nippon Denshoku Kogyo Co., Ltd.). The results are shown in Table 2.

### Comparative Example 1

In this comparative example, an image was formed in the same manner as in Example 1 except that the paper substrate itself was used as the image-recording sheet and evaluation was carried out. The results are shown in Table 2.

TABLE 2

| | Yellow | | Magenta | | Cyan | |
|---|---|---|---|---|---|---|
| | a* | b* | a* | b* | a* | b* |
| Example 1 | −8.25 | 93.44 | 64.38 | −18.97 | −30.98 | −41.24 |
| Comparative | −8.44 | 87.37 | 62.45 | −18.16 | −27.53 | −39.08 |
| Example 1 | | | | | | |

According to the results shown in Table 2, it can be seen that the chromas in the image-recording sheet of Example 1 were increased. Consequently, the inventive image-recording sheet has excellent color reproducibility and can provide a toned image with a high quality.

### Example 2

In this example, an image-recording sheet was produced in the same manner as in Example 1 except that an over coating composition was prepared by mixing the respective components shown in Table 3 and used, and the evaluation was carried out in the same manner as in Example 1 except the measurement of chroma.

TABLE 3

| Component | Parts by weight |
|---|---|
| aqueous polyester (WB 50 manufactured by 3M Co.) | 82.87 |
| di(butoxyethoxyethyl) adipate (BXA manufactured | 9.94 |
| by Daihachi Chemical Industry Co., Ltd.) | |
| poly(methyl methacrylate) beads (average particle | 0.08 |
| size of 8 μm; Techpolymer MBX-8 manufactured by | |
| Sekisui Plastics Co., Ltd.) | |
| surfactant (Zonyl FSN manufactured by Du Pont) | 0.32 |
| lithium nitrate | 0.17 |
| deionized water | 6.63 |

In this case, the image-receptive transparent layer was firmly adhered to the paper substrate, and the image-receptive transparent layer had a surface roughness Rz of 1.512 μm.

### Example 3

In this example, an image-recording sheet was produced in the same manner as in Example 1 except that an over coating composition used was prepared by mixing the respective components shown in Table 4 and a copy paper sheet (J coated paper; Rz=1.218 μm) manufactured by Fuji Xerox Co., Ltd. was used as the paper substrate, and evaluation was carried out in the same manner as in Example 1 except the measurement of chroma.

TABLE 4

| Component | Parts by weight |
|---|---|
| aqueous polyester (NeoCryl XK-90 Abysia Co., Ltd.) | 39.89 |
| di(butoxyethoxyethyl) adipate (BXA manufactured | 5.39 |
| by Daihachi Chemical Industry Co., Ltd.) | |
| poly(methyl methacrylate) beads (average particle | 0.09 |
| size of 8 μm; Techpolymer MBX-8 manufactured by | |
| Sekisui Plastics Co., Ltd.) | |
| surfactant (Zonyl FSN manufactured by Du Pont) | 0.34 |
| lithium nitrate | 0.18 |
| deionized water | 50.06 |

In this case, the image-receptive transparent layer was firmly adhered to the paper substrate, and the image-receptive transparent layer had a surface roughness Rz of 0.959 μm.

### Comparative Example 2

In this comparative example, an image-recording sheet was produced in the same manner as in Example 3 except that a copy paper sheet (Color Laser Copier paper; Rz=4.354 μm) manufactured by Canon Co., Ltd. was used in place of the copy paper manufactured by Fuji Xerox Co., Ltd. and the evaluation was carried out. In this case, the image-receptive transparent layer was firmly adhered to the paper substrate and the image-receptive transparent layer had a surface roughness Rz of 4.921 μm.

### Comparative Example 3

An image-recording sheet was produced in the same manner as in Example 1 except that an image-receptive transparent layer with the dry coating amount of 2.5 g/m² was formed using an over coating composition prepared by mixing the respective components shown in Table 5. In this case the surface roughness Rz of the image-receptive layer was 1.218 μm. However, in the image-recording sheet of this comparative example, hot-offset was caused at the time of forming a full color image and therefore, the evaluation of image was impossible.

TABLE 5

| Component | Parts by weight |
|---|---|
| di(butoxyethoxyethyl) adipate (BXA manufactured | 50.00 |
| by Daihachi Chemical Industry Co., Ltd.) | |
| methyl ethyl ketone (manufactured by Wako Pure | 50.00 |
| Chemical Industries, Ltd.) | |

### Example 4

In this example, first, a primer composition was produced by mixing the respective components shown in Table 6. Next, the prescribed amount of the obtained primer composition was applied with a Mayer bar to one surface of a paper substrate (Mirrorcoat manufactured by Oji Paper Mill, Ltd.; basis weight: 157.0 kg) having a ten-point average surface roughness (Rz) of 0.228 μm. After that, together with the paper substrate, the primer composition was heated to 100° C. and dried for 3 minutes to remove the solvent and form a gloss layer with a dry coating amount of 0.9 g/m². The refractive index of the gloss layer was 1.4952.

TABLE 6

| Component | Parts by weight |
|---|---|
| polyester (Atlac 382E manufactured by Reichhold | 20.00 |
| Chemical Co.) | |
| methyl ethyl ketone | 40.00 |
| toluene | 40.00 |

Next, an over coating composition was prepared by mixing the respective components shown in Table 7 and then the prescribed amount of the composition was applied with a Mayer bar to the previously formed gloss layer. After that, together with the paper substrate and the gloss layer, the over coating composition was heated 10 to 1 00C. and dried for 3 minutes to remove the solvent and form an image-receptive transparent layer with a dry coating amount of 4.0 g/m² to yield an image-recording sheet. The refractive index of the image-receptive layer was 1.4879.

TABLE 7

| Component | Parts by weight |
|---|---|
| aqueous polyurethane (Sancure 776 manufactured | 53.85 |
| by Gunze Ltd.) | |
| di(butoxyethoxyethyl) adipate (BXA manufactured | 5.66 |
| by Daihachi Chemical Industry Co., Ltd.) | |
| poly(methyl methacrylate) beads (average particle | 0.09 |
| size of 8 μm; Techpolymer MBX-8 manufactured by | |
| Sekisui Plastics Co., Ltd. | |
| deionized water | 40.40 |

In this case, the image-receptive transparent layer and the gloss layer were firmly adhered to each other and held on the paper substrate. The image-receptive transparent layer had a surface roughness Rz of 0.231 μm when measured using the same surface roughness meter as that used in Example 1.

Furthermore, a full color toned image was formed on the image-receptive transparent layer of the image-recording sheet in the same manner as in Example 1 and the gloss was measured in the same manner as in Example 1.

The gloss of each image-recording sheet produced in Examples 1 to 4 and Comparative Examples 1 to 2 is shown in Table 8.

According to the results in Table 8, it can be seen that all the image-recording sheets of Examples 1 to 4 had a high gloss in comparison with those of Comparative Examples 1 and 2. Consequently, the image-recording sheets of the present invention can provide a high quality toned image.

TABLE 8

| | Gloss (%) | | | | | | |
|---|---|---|---|---|---|---|---|
| | Black | Yellow | Magenta | Cyan | Red | Green | Blue |
| Example 1 | 51.3 | 38.2 | 26.9 | 24.3 | 28.1 | 24.9 | 32.0 |
| Example 2 | 33.3 | 24.4 | 21.3 | 16.5 | 23.9 | 22.8 | 21.6 |
| Example 3 | 39.8 | 18.4 | 19.1 | 14.0 | 27.0 | 20.0 | 17.8 |
| Example 4 | 78.2 | 55.0 | 45.2 | 31.2 | 53.7 | 43.7 | 40.5 |
| Comparative | 22.0 | 12.0 | 16.2 | 10.2 | 16.5 | 17.5 | 16.2 |
| Example 1 | | | | | | | |
| Comparative | 13.2 | 12.5 | 9.1 | 8.3 | 14.4 | 15.2 | 11.0 |
| Example 2 | | | | | | | |

### Example 5

In this example, an image-recording sheet was produced in the same manner as in Example 4 except that a paper substrate (Pearlcoat produced by Mitsubishi Paper Mills, Ltd.; basis weight: 127.9 kg) having a ten-point average surface roughness Rz 5 of 0.784 μm was used as the paper substrates and a gloss layer composition and an image-receptive layer composition used were prepared by mixing the components shown in Table 9 and Table 10, respectively and the evaluation was carried out in the same manner as in Example 1. In this case, the image-receptive transparent layer and the gloss layer were firmly adhered to one another and held on the paper substrate, and the image-receptive transparent layer had a surface roughness Rz of 0.835 μm. The refractive index of the image-receptive layer was 1.5044.

TABLE 9

| Component | Parts by weight |
|---|---|
| styrene-acrylic acid copolymer (Pliolite AC | 10.00 |
| manufactured by Goodyear Co.) | |
| methyl ethyl ketone | 45.00 |
| toluene | 45.00 |

TABLE 10

| Component | Parts by weight |
|---|---|
| styrene-acrylic acid copolymer (NeoCryl A-1092 | 40.32 |
| Abysia Co., Ltd.) | |
| aqueous carnauba wax dispersion (Selosol 524 | 3.19 |
| manufactured by Chukyo Yushi Co., Ltd.) | |
| poly(methyl methacrylate) beads (average particle | 0.10 |
| size of 8 μm; Techpolymer MBX-8 manufactured | |
| by Sekisui Plastics Co., Ltd.) | |
| deionized water | 26.38 |

### Comparative Example 3

In this comparative example, an image-recording sheet was produced in the same manner as in Example 5 except that no gloss layer was formed, and then the evaluation was carried out. In this case, the image-receptive transparent layer was firmly adhered to the paper substrate, and the image-receptive transparent layer had a surface roughness Rz of 0.770 μm.

The gloss of each image-recording sheet produced in Example 5 and Comparative Example 3 is shown in Table 11.

TABLE 11

| | Gloss (%) | | | | | | |
|---|---|---|---|---|---|---|---|
| | Black | Yellow | Magenta | Cyan | Red | Green | Blue |
| Example 5 | 49.7 | 45.9 | 50.1 | 35.1 | 70.2 | 73.7 | 71.4 |
| Comparative | 41.7 | 35.3 | 31.4 | 29.3 | 42.4 | 53.8 | 54.4 |
| Example 3 | | | | | | | |

According to the results in the Table 11, it can be seen that the image-recording sheets of Example 5 had a high gloss in comparison with that of Comparative Example 3. Consequently, the image-recording sheet of the present invention can provide a high quality toned image by forming the gloss layer.

1. An image-recording sheet comprising a paper substrate and an image-receptive layer formed at least one surface of the paper substrate, characterized in that the image-receptive layer has ten-point average surface roughness (Rz) of about 0.1 to 3.0 μm and contains a thermoplastic resin having a storage modulus of about 1×10³ to 1×10⁶ Pa at 160° C.

2. The image-recording sheet according to claim 1, characterized in that the image-receptive layer is transparent.

3. The image-recording sheet according to claim 1 further comprising a gloss layer disposed between the paper substrate and the image-receptive layer.

4. The image-recording sheet according to claim 3, characterized in that the gloss layer has a refractive index higher than that of the thermoplastic resin of the image-receptive layer by at least about 0.002 in terms of absolute values.

5. The image-recording sheet according to any one of claims 1 to 4, characterized in that the image-receptive layer contains a compatibilizer having a solubility parameter of about 8.0 to 10.0.
